(19) United States
(12) Patent Application Publication
(10) Pub. No.: US 2012/0206417 A1
(43) Pub. Date: Aug. 16, 2012

(54) INFORMATION INPUTTING DEVICE AND INFORMATION INPUTTING METHOD

(75) Inventor: Jae Jun Lee, Seoul (KR)

(73) Assignee: PENANDFREE CO., LTD., Seongnam-si (KR)

(21) Appl. No.: 13/305,461

(22) Filed: Nov. 28, 2011

(30) Foreign Application Priority Data
Feb. 15, 2011 (KR) 10-2011-0013394

(51) Int. Cl. G06F 3/043

(52) U.S. Cl. 345/177

(57) ABSTRACT

Provided are an information inputting device and an information inputting method capable of inputting information to a portable electronic apparatus by using a touch panel and an electronic pen. In the information inputting device and the information inputting method, the portable electronic apparatus including a touch panel is combined with a receiver which receives an ultrasonic wave signal and a reference signal, so that it is possible to input information by using the touch panel and to accurately input information by using the electronic pen which emits the ultrasonic wave signal.

### BACKGROUND OF THE INVENTION

1. Field of the Present Invention

The present invention relates to an information inputting device and an information inputting method, and particularly, to an information inputting device and an information inputting method capable of inputting information using a touch panel and an electronic pen.

2. Description of the Related Art

As information and communication technology has been developed, the performances of portable electronic apparatuses have been rapidly improved. In times past, mobile phones were mainly used for telephonic communication. Recently, smart phones capable of accessing the Internet and performing high-speed calculation to execute various application programs have been rapidly and widely spread. In addition, in order to overcome a narrow display area of the smart phone, portable and light-weighted tablet PCs have also been spread.

In order to improve portability of the portable electronic apparatus, it is necessary to reduce its volume and weight. Therefore, touch panels capable of displaying and inputting information have been gradually substituted for keyboards and touch pads employed in notebook computers and mobile phones in the related art. Recently, capacitive touch panels rather than resistive touch panels have been mainly used for the portable electronic apparatus.

However, in the capacitive touch panel, information can be input only if the panel is touched with a portion of human body. Therefore, there is a problem in that delicate inputting is almost impossible. In other words, in the case where a user performs handwriting input by touch the touch panel with a finger, the touched area of the finger with respect to the touch panel is relatively wide, so that detailed handwriting inputting is impossible. In addition, in the case where the user selects a specific button among various selection buttons displayed on a web page, the touched area of the finger may overlap another button adjacent to the button which the user desires to select. Therefore, there is a problem in that an unexpected item may be selected.

### SUMMARY OF THE INVENTION

The present invention is to provide an information inputting device and an information inputting method where a portable electronic apparatus including a touch panel is combined with the information inputting device which can accurately input information by using an ultrasonic wave signal, so that it is possible to simultaneously perform inputting information using the touch panel in the related art and accurately inputting information by using the ultrasonic wave signal.

The present invention is to provide an information inputting device and an information inputting method capable of recognizing user's intention and automatically switching between an information inputting method using a touch panel and an information inputting method using an ultrasonic wave signal according to user's intention.

According to an aspect of the present invention, there is provided an information inputting device including: an ultrasonic wave reception unit which receives an ultrasonic wave signal generated by an electronic pen; a reference signal reception unit which receives a reference signal generated by the electronic pen; a position measurement unit which measures a position of the electronic pen by using a time difference between a reception time of the reference signal received by the reference signal reception unit and a reception time of the ultrasonic wave signal received by the ultrasonic wave reception unit and inputs second position information indicating the position of the electronic pen; and an input means selection unit which outputs first position information input from a touch panel, which senses user's contact and outputs the first position information, or the second position information according to user's intention of use.

In addition, the input means selection unit may determine a user's touched area on the touch panel by using the first position information, outputs the second position information if the touched area exceeds a predetermined first threshold value, and outputs first position information if the touched area does not exceed the first threshold value.

In addition, the input means selection unit may check by using the second position information whether or not the electronic pen is located on the touch panel and outputs the second position information in the case where the electronic pen is located on the touch panel.

In addition, the position measurement unit may measure a three-dimensional position of the electronic pen and output the second position information to the input means selection unit, and the input means selection unit may output the second position information in the case where the electronic pen is located on the touch panel and the electronic pen is located within a predetermined height from the touch panel.

In addition, the information inputting device may further include an approach indication signal reception unit which receives an approach indication signal from the electronic pen, and the input means selection unit may output the second position information in the case where an intensity of a signal received by the approach indication signal reception unit exceeds a predetermined second threshold value.

In addition, the electronic pen may emit the ultrasonic wave signal toward the touch panel so that the ultrasonic wave signal propagates along a surface of the touch panel. In addition, the electronic pen may include: a body portion where an ultrasonic wave signal generation unit which generates the ultrasonic wave signal is installed; and a guide portion which contains the ultrasonic wave signal generation unit therein and is engaged with the body portion so that the ultrasonic wave signal generated by the ultrasonic wave signal generation unit is emitted toward the touch panel.

In addition, the guide portion may have so thick an outer wall that there is no minute ultrasonic wave signal which is generated due to vibration transmitted when the ultrasonic wave signal is generated in the body portion.

In addition, a vibration absorbing portion may be disposed in a periphery of the guide portion to prevent an ultrasonic wave signal from being generated due to vibration of the guide portion.

In addition, the vibration absorbing portion may be made of a material capable of absorbing or blocking vibration.

In addition, the vibration absorbing portion may be made of any one of a rubber, a silicon, a high-density synthetic sponge, a metal, and a plastic.

In addition, the guide portion may include an ultrasonic wave emitting portion which emits the ultrasonic wave signal in one direction, and the ultrasonic wave signal generated by the ultrasonic wave signal generation unit may propagate through a guide path formed between an inner surface of the guide portion and the ultrasonic wave signal generation unit contained therein to be emitted through the ultrasonic wave emitting portion.

In addition, the body portion may be provided with an ultrasonic wave blocking portion which is in close contact with an inner surface of the guide portion to block the ultrasonic wave signal so as for the ultrasonic wave signal to propagate in only one direction.

According to another aspect of the present invention, there is provided is a method of inputting information to a portable electronic apparatus in an information inputting device combined with the portable electronic apparatus including a touch panel, including steps of: (a) in the information inputting device, determining which input means between the touch panel and an electronic pen a user is to use to input information; (b) in the case where it is determined that the user is to input information by using the touch panel, in the information inputting device, outputting first position information indicating a position of the touch panel touched by the user, which is input from the touch panel, to the portable electronic apparatus; and (c) in the case where it is determined that the user is to input information by using the electronic pen, in the information inputting device, outputting second position information indicating a position of the electronic pen to the portable electronic apparatus.

In addition, the step (a) may include steps of: (a1) receiving an area (touched area) of the touch panel touched by the user as an input from the touch panel; (a2) determining which input means the user is to use to input information by comparing the touched area with a predetermined first threshold value; and (a3) in the case where the user is to use the electronic pen to input information, measuring the position of the electronic pen by using a time difference between the ultrasonic wave signal and a reference signal generated by the electronic pen to generate the second position information.

In addition, the step (a) may include steps of: (a1) in the information inputting device, measuring the position of the electronic pen by using a time difference between the ultrasonic wave signal and the reference signal generated by the electronic pen to generate the second position information; and (a2) in the information inputting device, determining an area where the electronic pen is located and determining which input means the user is to use.

In addition, in the step (a2), in the case where the electronic pen is located above the touch panel, it may be determined that the user is to input information by using the electronic pen.

In addition, in the step (a1), a three-dimensional position of the electronic pen may be measured, and in the step (a2), in the case where the electronic pen is located above the touch panel and within a predetermined height from the touch panel, it may be determined that the user is to input information by using the electronic pen.

In addition, the step (a) may include steps of: (a1) receiving an approach indication signal indicating that the electronic pen is operating from the electronic pen; (a2) determining which input means the user is to use by comparing the intensity of the approach indication signal with a predetermined threshold value; and (a3) in the case where the user is to use the electronic pen to input information, measuring the position of the electronic pen by using a time difference between the ultrasonic wave signal and the reference signal generated by the electronic pen to generate the second position information.

In the information inputting device and the information inputting method according to the present invention, a portable electronic apparatus including a touch panel is combined with a receiver which can receive an ultrasonic wave signal and a reference signal, it is possible to input information by using the touch panel and to accurately input information by using the electronic pen which emits the ultrasonic wave signal.

In addition, according to the present invention, it is possible to recognize user's intention and to automatically switch between the information inputting method using the touch panel and the information inputting method using the ultrasonic wave signal according to user's intention.

In addition, according to the present invention, the electronic pen used for inputting information is configured to emit an ultrasonic wave toward only the touch panel, so that it is possible to minimize the height of a receiver module combined with the portable electronic apparatus.

### BRIEF DESCRIPTION OF THE DRAWING

FIG. 1a is a block diagram illustrating a configuration of an information inputting device according to an embodiment of the present invention.

FIGS. 1b to 1d are diagrams illustrating an example where the information inputting device 100 according to the embodiment of the present invention is implemented.

FIGS. 2a to 2c are diagrams for explaining methods of determining an input means which is to be used by a user.

FIG. 3 is a flowchart for explaining an information inputting method according to an embodiment of the present invention.

FIGS. 4a to 4c are flowcharts for explaining a method of determining an input means which is to be used by a user in Step S310 of FIG. 3.

FIG. 5a is a diagram illustrating an example where a signal reception module of the information inputting device according to the present invention is combined with a portable electronic apparatus.

FIG. 5b is a diagram for explaining a problem which occurs when a conventional electronic pen is used.

FIG. 6 is a diagram illustrating a structure of an electronic pen according to the embodiment of the present invention.

FIG. 7 is a diagram illustrating an example where the electronic pen according to the embodiment of the present invention is used to input information.

FIG. 8 is a diagram illustrating an ultrasonic wave signal emitted from an ultrasonic wave emitting portion and a waveform of an ultrasonic wave signal generated by vibration of a guide portion.

FIGS. 9a to 9d are diagrams for explaining a method of measuring a three-dimensional position of an electronic pen.

### DESCRIPTION OF THE PREFERRED EMBODIMENTS

Hereinafter, embodiments of the present invention will be described with reference to the accompanying drawings.

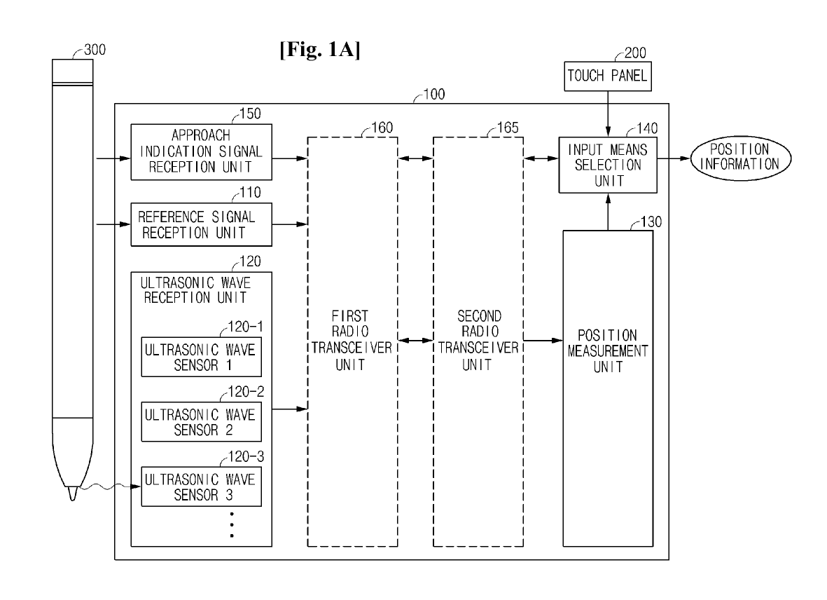

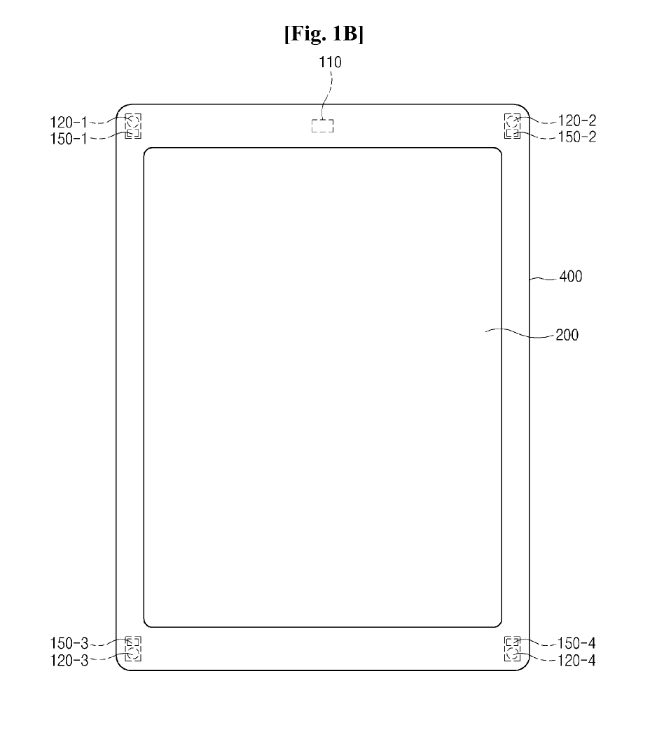

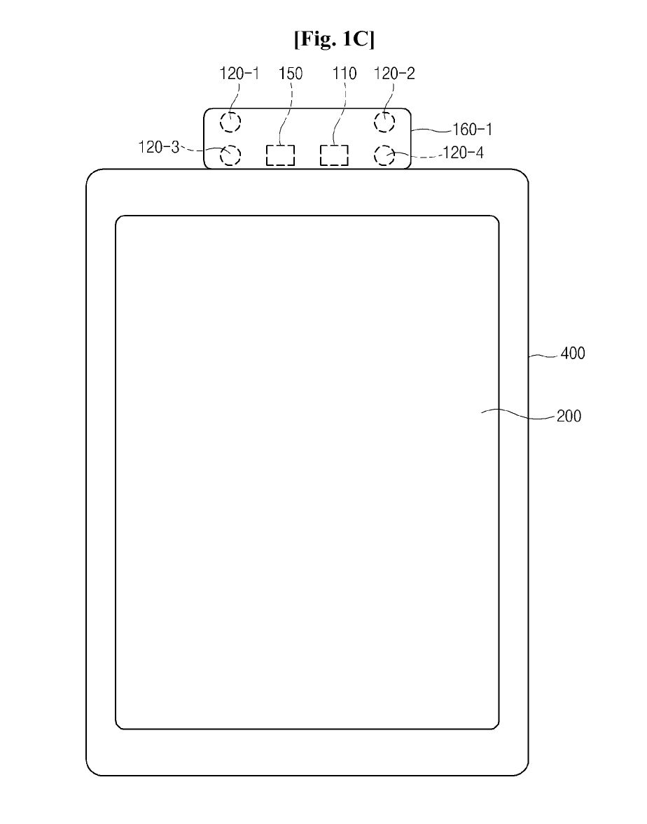

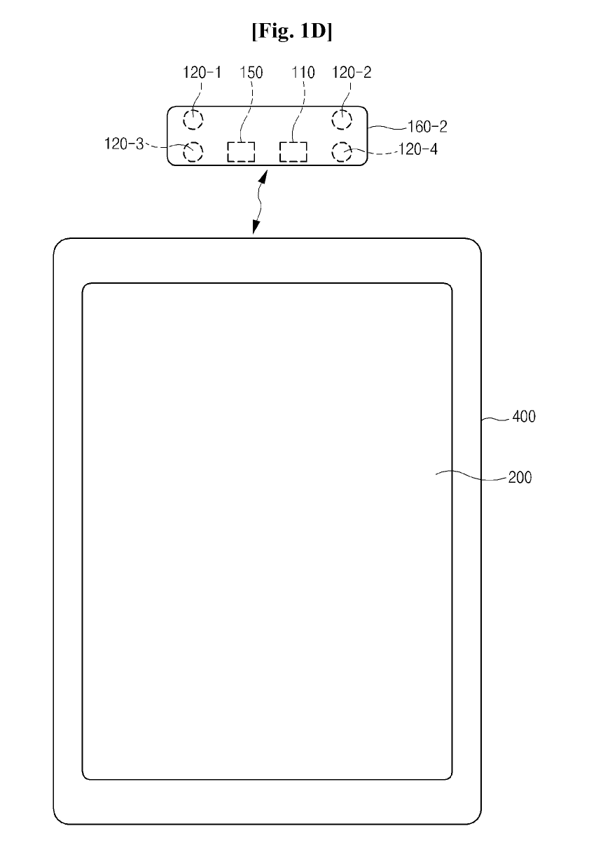

FIG. 1a is a block diagram illustrating a configuration of an information inputting device according to an embodiment of the present invention, and FIGS. 1b to 1d are diagrams illustrating an example where the information inputting device 100 according to the embodiment of the present invention is implemented.

Referring to First, FIG. 1a, the information inputting device 100 according to the present invention mainly includes an ultrasonic wave reception unit 120, a reference signal reception unit 110, a position measurement unit 130, and an input means selection unit 140. The ultrasonic wave reception unit 120 includes two or more ultrasonic wave sensors 120-1, 120-2, 120-3, . . . .

In addition, in some embodiments, the aforementioned information inputting device 100 may further include one or more approach indication signal reception units 150, a first radio transceiver unit 160, and a second radio transceiver unit 165.

First, an example where the information inputting device 100 according to the present invention is combined with a portable electronic apparatus will be described with reference to FIGS. 1b to 1d.

Referring to FIG. 1b, the components of the aforementioned information inputting device 100 according to the present invention may be built in the portable electronic apparatus 400 such as a tablet PC.

As illustrated in the example of FIG. 1b, the two or more ultrasonic wave sensors 120-1,120-2,120-3, and 120-4 constituting the ultrasonic wave reception unit 120 may be disposed at a plurality of the positions of the portable electronic apparatus 400 (disposed at the corners in the illustrated example) to receive the ultrasonic wave signal generated by the electronic pen 300. Similarly, one or more approach indication sensors 150-1,150-2,150-3,150-4 constituting the approach indication signal reception unit 150 may also be disposed at a plurality of the positions of the portable electronic apparatus 400 to receive the approach indication signal generated by the electronic pen 300. In addition, the one or more approach indication sensors 150-1,150-2,150-3,150-4 may be configured by directional sensors so as to sense the electronic pen 300 which approaches in a specific direction.

As illustrated in the example of FIG. 1c, the ultrasonic wave reception unit 120, the reference signal reception unit 110, and the approach indication signal reception unit 150 of the aforementioned information inputting device 100 according to the present invention may be disposed in the signal reception module 160. The signal reception module 160 is inserted into an input/output port such as a USB port of the portable electronic apparatus 400 such as a tablet PC to be combined with the portable electronic apparatus 400. The position measurement unit 130 and the input means selection unit 140 may be implemented with software in the microprocessor of the portable electronic apparatus 400.

In the example illustrated FIG. 1c, since the position of the signal reception module 160-1 combined with the portable electronic apparatus 400 is fixed with respect to the portable electronic apparatus 400, the initial position thereof may be set in advance by a manufacturer of the information inputting device 100 according to the present invention.

As illustrated in the example of FIG. 1d, among the aforementioned components of the information inputting device 100 according to the present invention, the ultrasonic wave reception unit 120, the reference signal reception unit 110, the approach indication signal reception unit 150, and the first radio transceiver unit 160 are included in a signal reception module 160-2, and the other components are included in the portable electronic apparatus 400. Information on signals received by the signal reception module 160-2 may be transmitted to the position measurement unit 130 and the input means selection unit 140, which are installed in the portable electronic apparatus 400 in a software manner, through wireless local area network communication such as Bluetooth communication.

In the example illustrated FIG. 1d, a user may allow the signal reception module 160-2 to be located at an arbitrary position in the vicinity of the portable electronic apparatus 400. Therefore, the user needs to perform initial position setting of the signal reception module. The initial position setting may be performed by pointing the corresponding area (for example, the edge of the touch panel) of the touch panel 200 by using the electronic pen 300.

In the later description of the information inputting device 100 according to the present invention, only the information inputting process performed by the information inputting device 100 according to the present invention in connection with a basic configuration of a portable electronic apparatus are described. It should be noted that first position information and second position information output from the input means selection unit 140 are used as input signals of the portable electronic apparatus in the same manner as that of position information output from the touch panel 200.

Referring to FIG. 1 again, functions of the components of the information inputting device 100 according to the present invention are described. The ultrasonic wave reception unit 120 and the reference signal reception unit 110 receive an ultrasonic wave signal and a reference signal emitted from the electronic pen 300, respectively.

The electronic pen 300 generates the ultrasonic wave signal and the reference signal such as an IR signal or an RF signal simultaneously or by a certain time difference.

The ultrasonic wave reception unit 120 includes a plurality of the ultrasonic wave sensors 120-1, 120-2, and 120-3 which are separated from each other by a predetermined distance and receives the ultrasonic wave signal emitted from the electronic pen 300 to output the ultrasonic wave signal to the position measurement unit 130.

The reference signal reception unit 110 receives the reference signal generated by the electronic pen 300 to output the reference signal to the position measurement unit 130.

The approach indication signal reception unit 150 receives an approach indication signal, which is generated by the electronic pen 300 in the ON state to indicate that the electronic pen 300 is operating separately from the ultrasonic wave signal and the reference signal, to output the approach indication signal to the input means selection unit 140. As described above, the approach indication signal reception unit 150 may be included or omitted as a component in some embodiments.

The first radio transceiver unit 160 and the second radio transceiver unit 165 are components included in the information inputting device 100 in the case where the reference signal reception unit 110, the ultrasonic wave reception unit 120, and the approach indication signal reception unit 150 described above are included in the signal reception module 160-2 illustrated in FIG. 1d. The first radio transceiver unit 160 included in the signal reception module 160-2 transmits information on signals received by the reception units to the second radio transceiver unit 165 in a wireless manner, and the second radio transceiver unit 165 outputs information on the approach indication signal received by the first radio transceiver unit 160 to the input means selection unit 140 and outputs information on the ultrasonic wave signal and the reference signal to the position measurement unit 130. These radio transceiver units may be omitted in the case of a wired configuration.

The position measurement unit 130 measures a coordinate of the electronic pen 300 by using a time difference between a reception time of the reference signal received by the reference signal reception unit 110 and a reception time of the ultrasonic wave signal received by each of the ultrasonic wave sensors 120-1,120-2, 120-3, and 120-4 of the ultrasonic wave reception unit 120.

In other words, assuming that the electronic pen 300 simultaneously generates the reference signal and the ultrasonic wave signal, the reference signal which propagates at the speed of light is received by the reference signal reception unit 110 at the same time of the generation. Therefore, the reception time of the reference signal may be considered to be the generation time of the ultrasonic wave signal generated by the electronic pen 300. Since the ultrasonic wave signal propagates at a speed of 340 m/s, the time difference between the reception time of the reference signal and the reception time of the ultrasonic wave signal may be considered to be the time taken for the ultrasonic wave signal to propagate from the electronic pen 300 to each of the ultrasonic wave sensors 120-1,120-2, 120-3, and 120-4. Therefore, the distances from the electronic pen 300 to the respective ultrasonic wave sensors 120-1,120-2, 120-3, and 120-4 can be calculated. In addition, the distances among the ultrasonic wave sensors 120-1,120-2, 120-3, and 120-4 are defined in advance. Therefore, since lengths of sides of a triangle having the position of the electronic pen 300 and the positions of the ultrasonic wave sensors 120-1,120-2, 120-3, and 120-4 as three vertexes are known values, two-dimensional or three-dimensional coordinate of the electronic pen 300 can be simply determined by using trigonometric formulas.

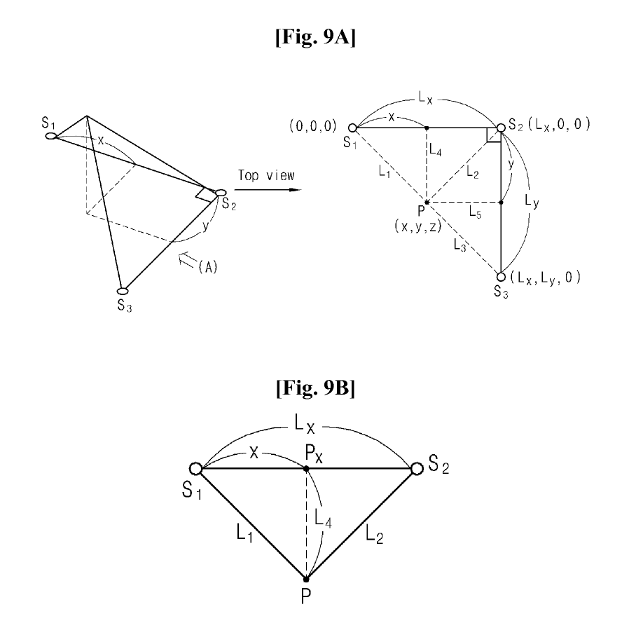

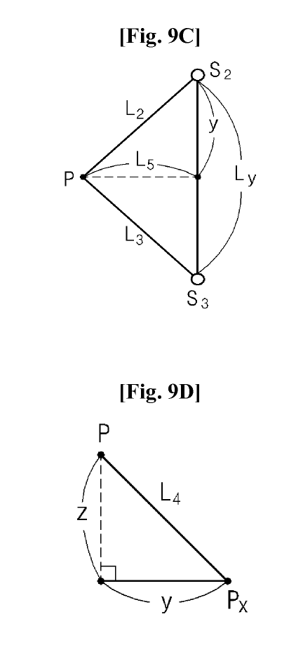

The method of measuring the two-dimensional position of the electronic pen 300 is described in detail in the prior published applications filed by the inventor, and thus, the detailed description thereof is omitted. The method of measuring the three-dimensional position of the electronic pen 300 is described with reference to FIGS. 9a to 9d.

First, as illustrated in FIG. 9a, three sensors constituting the ultrasonic wave signal reception unit 120 are indicated by S1, S2, and S3. As illustrated in FIG. 9a, the sensors are disposed to be perpendicular to each other on the same plane. For the convenience of description, the coordinates are indicated by (0, 0, 0), (Lx, 0, 0), and (Lx, Ly, 0), and the three-dimensional position (P) coordinate of the electronic pen 300 is indicated by (x, y, z).

In this case, the distance Lx between S1 and S2 and the distance Ly between the sensor S2 and the sensor S3 are known values. The distance L1 between the electronic pen 200 and the sensor S1, the distance L2 between the electronic pen 200 and the sensor S2, and the distance L3 between the electronic pen 200 and the sensor S3 can be obtained by using a time difference between the reception time of the reference signal and the reception time of the ultrasonic wave signal as described above.

With respect to the x coordinate of the electronic pen 200, as illustrated in FIG. 9b, if a triangle having three sides having lengths L1, L2, and Lx is set, the following Equation 1 is satisfied. By solving Equation 1 with respect to x, the value of the x coordinate can be obtained as expressed by the following Equation 2.

L₁²=x²+L₄²

L₂²=(Lₓ−x)²+L₄² [Equation 1]

$$x = \frac{{L}_{x}^{2} + {L}_{1}^{2} - {L}_{2}^{2}}{2 {L}_{x}} \qquad [ Equation 2 ]$$

On the other hand, with respect to the y coordinate of the electronic pen 200, as illustrated in FIG. 9c, if a triangle having three sides having lengths L2, L3, and Ly is set, similarly to the method of calculating the aforementioned Equation 1, the value of the y coordinate can be obtained as expressed by the following Equation 3.

$$y = \frac{{L}_{y}^{2} + {L}_{2}^{2} - {L}_{3}^{2}}{2 {L}_{y}} \qquad [ Equation 3 ]$$

In addition, as seen in the direction A in FIG. 9a, as illustrated in FIG. 9d, if a triangle having three sides having lengths L4, y, and z is set, the value of the z coordinate can be obtained as expressed by the following Equation 4.

z=\sqrt{L₁²−x²−y²} [Equation 4]

As described above, the three-dimensional coordinate values of the electronic pen 200 can be obtained by using Equations 1 to 4. In addition, the position coordinate of the electronic pen 200 may also be measured by using a method other than the method using Equations 1 to 4 described above.

The input means selection unit 140 is input with the first position information from the touch panel 200 and input with the second position information from the position measurement unit 130. In addition, the input means selection unit 140 checks user's intention as to which input means between the touch panel 200 and the electronic pen 300 the user is to uses to input information. In the case where the user is to input information by using the touch panel 200, the input means selection unit 140 outputs the first position information. In the case where the user is to input information by using the electronic pen 300, the input means selection unit 140 outputs the second position information as the input position information.

The input means selection unit 140 checks the user's intention by using one of the following three methods to switch between the input method using the touch panel 200 and the input method using the electronic pen 300.

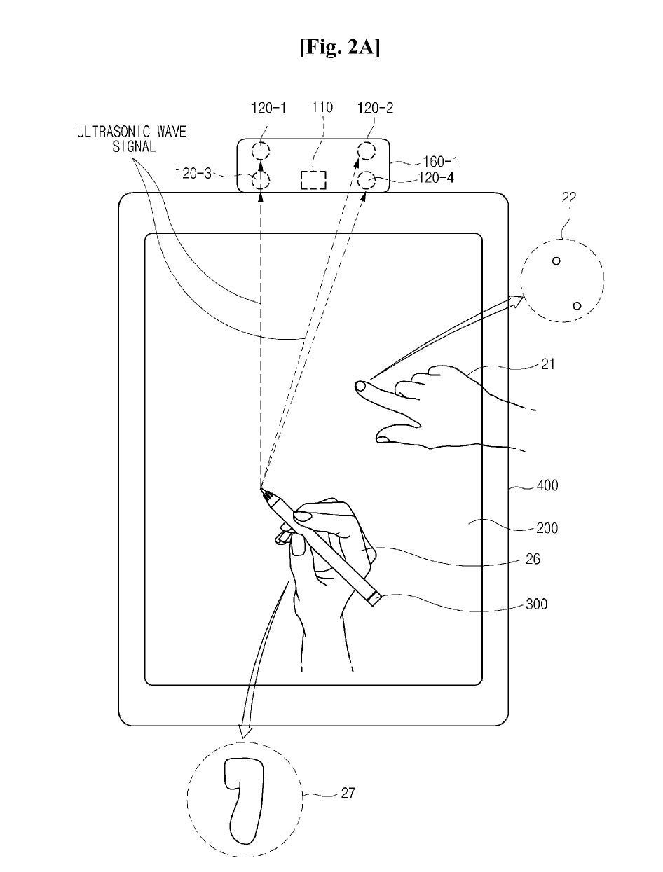

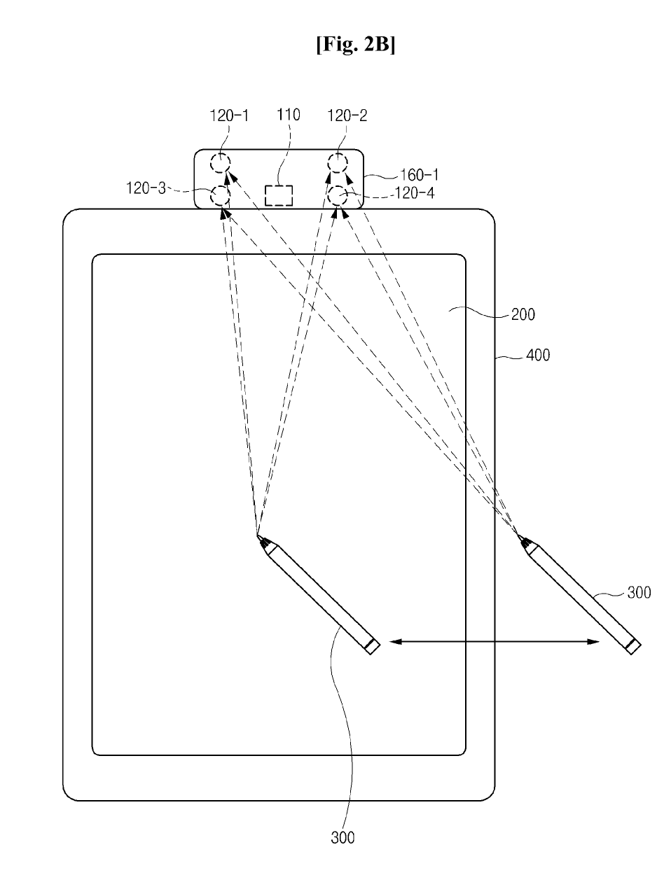

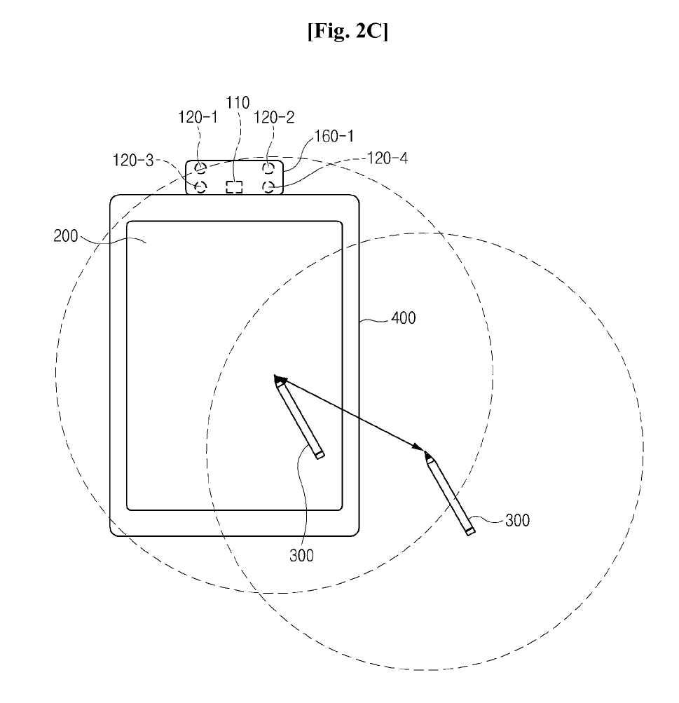

FIGS. 2a to 2c are diagrams for explaining three methods of checking the user's intention, switching the input method, and outputting the position information. Although FIGS. 2a to 2c illustrate an example where the signal reception module 160-1 according to the present invention is combined with the portable electronic apparatus 400 through input/output ports (refer to FIG. 1c), the same method can also be applied to the example illustrated in FIGS. 1b and 1d.

First, the first input means switching method is described with reference to FIG. 2a. The input means selection unit 140 can check the user's intention by determining whether or not a touching area of user's body with respect to the touch panel 200 exceeds a predetermined threshold value.

For example, in the case where the user is to input information by touching the touch panel 200 with a finger, as illustrated by reference numeral 21, the user touches the touch panel 200 generally by using a fingertip. At this time, a touching area of the finger with respect to the touch panel 200 is a very small area as illustrated by reference numeral 22.

On the contrary, in the case where the user is to input information by using the electronic pen 300, the user needs to input handwriting by touching the touch panel 200 with the electronic pen 300 and to select a button. In this case, as illustrated by reference numeral 26, the user puts the hand on the touch panel 200. Therefore, as illustrated by reference numeral 27, a larger area of the touch panel 200 is touched with the user's body in comparison with the case where the user is to input information by touching the touch panel 200 with the finger (refer to reference numeral 22). Therefore, the input means selection unit 140 measures the touched point and touched area of the touch panel 200. In the case where the touched area or the touched point exceeds a predetermined threshold value, it is determined that the user is to input information by using the electronic pen 300, the input means selection unit 140 outputs the second position information input from the position measurement unit 130. In the case where the touched area or the touched point does not exceed the threshold value, the input means selection unit 140 outputs the first position information again, so that the switching between the touch panel inputting method and the electronic pen inputting method can be simply performed according to the user's intention.

The second input means switching method is described with reference to FIG. 2b. The input means selection unit 140 determines based on the second position information of the electronic pen 300, which is input from the position measurement unit 130, whether the user is to use the touch panel 200 or the user is to input information by using the electronic pen 300.

In the case where the user is to accurately input information by using the electronic pen 300 during the process where the user inputs information by using the touch panel 200, the user turns on the electronic pen 300 to generate the reference signal and the ultrasonic wave signal and moves the electronic pen 300 from the outside of the touch panel 200 to the inside of the touch panel 200.

Therefore, as illustrated in FIG. 2b, when the electronic pen 300 is located outside the touch panel 200, the input means selection unit 140 outputs the first position information input from the touch panel 200. When the electronic pen 300 is moved to the inside of the touch panel 200, it is determined that the user is to input information by using the electronic pen 300, the input means selection unit 140 outputs the second position information input from the position measurement unit 130.

At this time, in the case where the ultrasonic wave reception unit 120 includes three or more ultrasonic wave sensors, the position measurement unit 130 may measure the three-dimensional position of the electronic pen 300 to output the three-dimensional position to the input means selection unit 140. In the case where the two-dimensional position of the electronic pen 300 is located inside the touch panel 200 and the height of the electronic pen 300 is within a predetermined distance from the touch panel 200 (for example, within a height of 1 cm from the touch panel 200), it is determined that the user is to input information by using the electronic pen 300, the input means selection unit 140 outputs the second position information input from the position measurement unit 130.

The third input means switching method is described with reference to FIG. 2c. Besides the ultrasonic wave signal and the reference signal, the electronic pen 300 according to the present invention may separately generate an approach indication signal (implemented by using a sound wave, an electromagnetic wave, a light amount, or the like) indicating that the electronic pen 300 is operating.

Since the intensity of the signal generated by the electronic pen 300 is decreased as the distance from the electronic pen 300 is increased, the input means selection unit 140 can measure the distance between the electronic pen 300 and the approach indication signal reception unit 150 by measuring the intensity of the approach indication signal. In the case where the intensity of the approach indication signal is increased to be equal to or larger than a predetermined threshold value, it is determined that a user locates the electronic pen 300 above the touch panel 200 so as to input information by using the electronic pen 300, so that the second position information input from the position measurement unit 130 is output instead of the first position information input from the touch panel 200. In FIG. 2c, the distance where the intensity of the approach indication signal is equal to or larger than the threshold value is indicated by dotted lines.

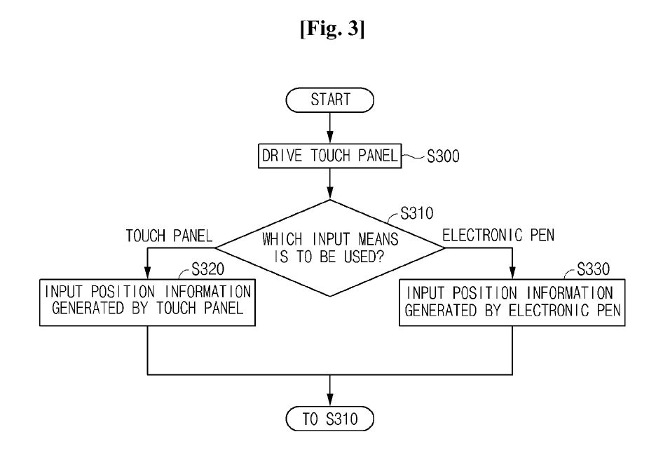

FIG. 3 is a flowchart for explaining an information inputting method according to an embodiment of the present invention. The information inputting method according to the embodiment of the present invention is described with reference to FIG. 3. First, if a portable electronic apparatus is driven, the touch panel 200 is also driven, so that the state where information can be input by using the touch panel 200 is established (S310).

Next, the information inputting device 100 checks which input means between the touch panel 200 and the electronic pen 300 the user is to use to input information (S310). In the case where the user is to use the touch panel 200, the information inputting device 100 outputs the first position information generated by the touch panel 200 to input information by using the touch panel 200 (S320).

On the other hand, as a result of the checking in Step S310 described above, if it is determined that the user is to input information by using the electronic pen 300, the information inputting device 100 inputs information by using the second position information indicating the position of the electronic pen 300 (S330).

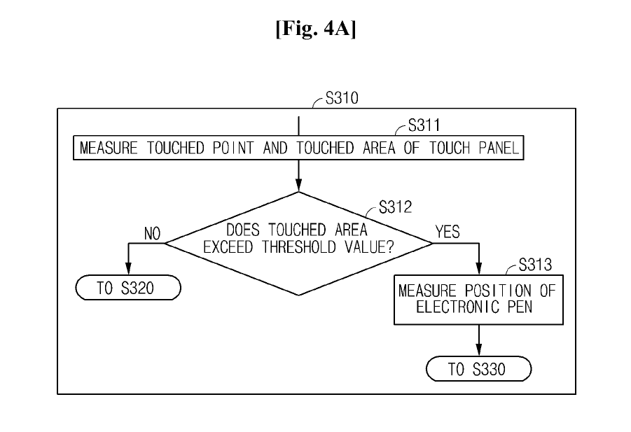

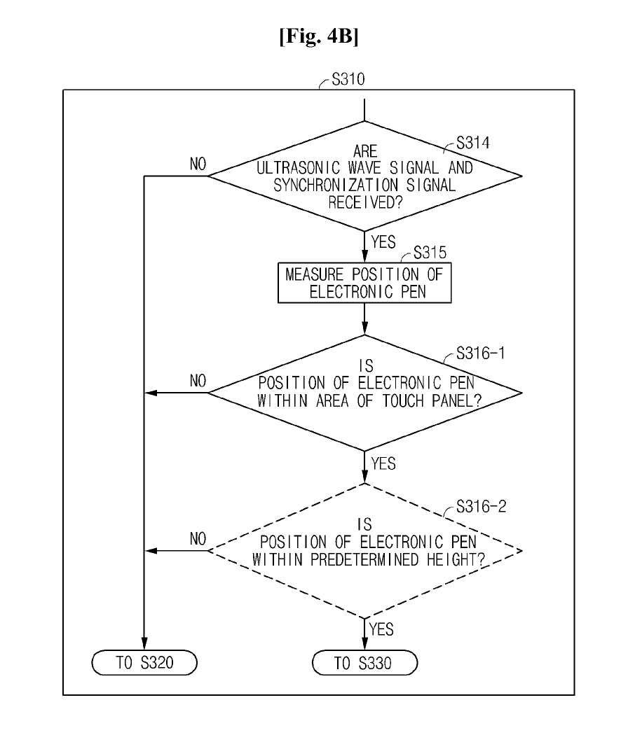

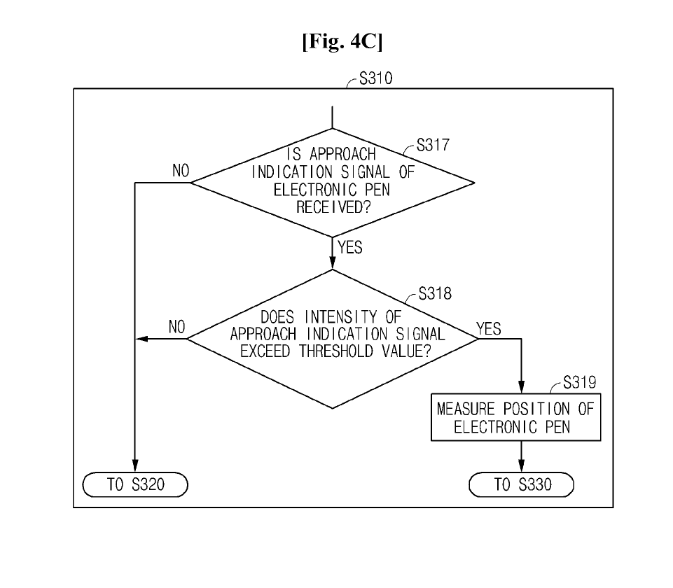

FIGS. 4a to 4c are flowcharts for explaining a method of determining the input means which is to be used by the user in Step S310 of FIG. 3.

First, referring to FIG. 4a, after the touch panel 200 is driven, the information inputting device 100 measures a touched point and a touched area of the touch panel 200 which is touched by the user (S311). Next, it is determined whether or not the touched area or the number of the touched points exceeds a predetermined threshold value, and if the touched area or the number of the touched points does not exceed the threshold value, the process proceeds to Step S320 (S312).

In Step S312, if it is determined that the touched area or the number of the touched points exceeds the threshold value, it is determined that the user grips the electronic pen 300 with the hand and puts the hand on the touch panel 200, so that the information inputting device 100 receives the reference signal and the ultrasonic wave signal to measure the position of the electronic pen 300, and the process proceeds to Step S330 (S313).

On the other hand, another method of determining the user's intention is described with reference to FIG. 4b. After the touch panel 200 is driven, the information inputting device 100 checks whether or not the ultrasonic wave signal and the reference signal are received. If the reference signal and the ultrasonic wave signal are not input, the process proceeds to Step S320 to input information by using the touch panel 200 (S314). If the ultrasonic wave signal and the reference signal are received, the position of the electronic pen 300 is measured by using the received signals as described above (S315).

Next, it is checked whether or not the position of the electronic pen 300 is within the area of the touch panel. In the case where the position of the electronic pen 300 is within the area of the touch panel 200, the process proceeds to Step S330 to input information by using the position information of the electronic pen 300. In the case where the position of the electronic pen 300 is not within the touch panel 200, the process proceeds to Step S320 to input information by using the touch panel 200 (S316-1).

On the other hand, in the case where the ultrasonic wave reception unit 120 includes three or more ultrasonic wave sensors to measure a three-dimensional position of the electronic pen 300, if the position of the electronic pen 300 is within the area of the touch panel 200 as a result of the checking in Step S316-1 described above, it is determined whether or not the height of the electronic pen 300 is equal to or less than a predetermined height from the touch panel 200. Only in the case where the height of the electronic pen 300 is equal to or less than the predetermined height (for example, the height of the electronic pen is 1 cm or less from the touch panel), the process proceeds to Step S330 to input information by using the position information of the electronic pen 300. If the height of the electronic pen 200 exceeds the predetermined height (for example, the height of the electronic pen 200 exceeds 1 cm from the touch panel), the process proceeds to Step S320 to input information by using the touch panel 200 (S316-2).

On the other hand, still another method of determining the user's intention is described with reference to FIG. 4c. The information inputting device 100 checks whether or not an approach indication signal of the electronic pen 300 is received. If the approach indication signal of the electronic pen 300 is not received, the process proceeds to Step S320 to input information by using the first position information output from the touch panel 200 (S317). If the approach indication signal of electronic pen 300 is received, it is checked whether or not the intensity of the approach indication signal exceeds a predetermined threshold value. In the case where the intensity of the approach indication signal does not exceed the threshold value, the process also proceeds to Step S320 (S318).

In Step S318, in the case where the intensity of the approach indication signal exceeds the threshold value, the position of the electronic pen 300 is measured by using the reference signal and the ultrasonic wave signal, and the process proceeds to Step S330 to input information by using the second position information of the electronic pen 300 (S319).

Hereinbefore, the information inputting device 100 and the information inputting method according to the embodiment of the present invention are described. Hereinafter, the electronic pen 300 used in the embodiment of the present invention is described.

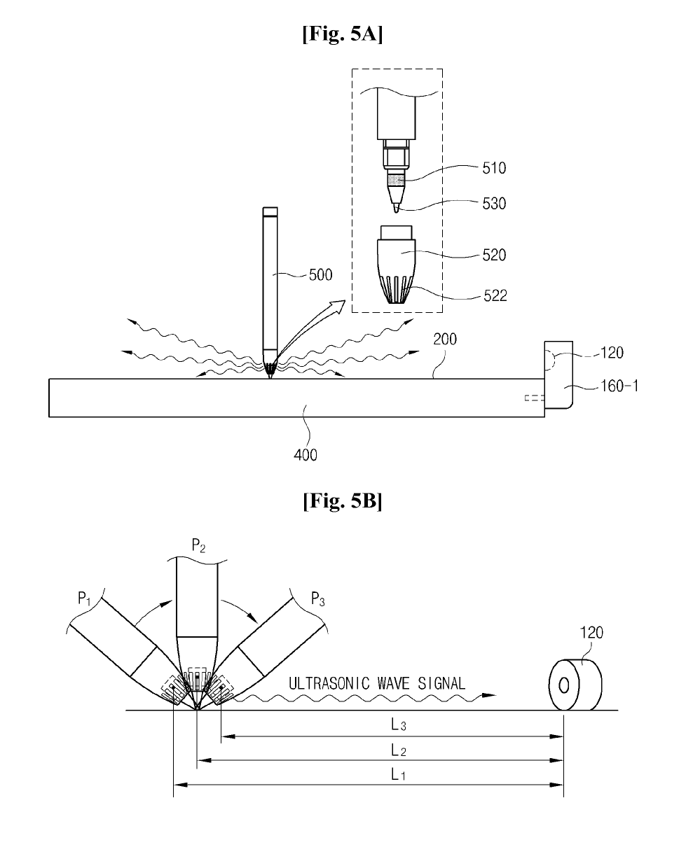

FIG. 5a illustrates an example where the signal reception module 160-1 is combined with a portable electronic apparatus.

In a structure of a currently-commercialized electronic pen 500 which emits an ultrasonic wave signal, as illustrated in FIG. 5, an ultrasonic wave generation unit 510 which is embodied with a piezo film is installed at the lower end of the electronic pen 500 so as to surround a pen core portion; a cap portion 520 is formed to protect the periphery of the ultrasonic wave generation unit 510 so that the ultrasonic wave generation unit 510 is not touched by a user; and emitting holes 522 are formed on the cap portion 520 so that the ultrasonic wave signal generated by the ultrasonic wave generation unit can be emitted.

However, as illustrated in FIG. 5a, since the ultrasonic wave signal emitted through the emitting holes 522 spread upwards and downward, only a portion of the ultrasonic wave signal is directly received by the ultrasonic wave sensors 120-1 and 120-2 of the signal reception module 160. In addition, in the case where the ultrasonic wave generation unit is driven somewhat strongly, the sound wave is received by other receiver sets in the vicinity thereof, so that crosstalk may easily occur due to the influence of the sound wave. Therefore, the ultrasonic wave generation unit needs to be driven with a small intensity, and in order to receive much more the ultrasonic wave signal, the ultrasonic wave reception sensors 120-1 and 120-2 need to be installed at the positions higher than the height of the touch panel 200. However, it may be expected that the signal reception module 160 which is installed to be highly protruded from the surface of the touch panel 200 causes inconvenience to the user in terms of use.

In addition, in the case of using an electronic pen 500 in the related art, the user inputs information and performs handwriting by touching the touch panel 200 with the pen core portion 530. Although the pen core portion 530 of the electronic pen 500 is located at the same position during the user's handwriting, the ultrasonic wave generation unit 510 may be moved in the order of a position P1, a position P2, and a position P3 according to the an orientation and a degree of tilt of the electronic pen 500 with respect to the surface of the touch panel 200. In this case, as illustrated, although the distance from the pen core portion to the electronic pen 300 and the distance from the pen core portion to the ultrasonic wave reception unit 120 are equal to each other, the distance of the electronic pen 500 recognized by the information inputting device 100 may be differently recognized according to the orientation and the degree of tilt of the electronic pen 500. In other words, in the case of the position P1, the distance is recognized to be L1; in the case of the position P2, the distance is recognized to be L2; and in the case of the position P3, the distance is recognized to be L3. This error in distance causes incorrect information inputting.

Particularly, when the user rapidly changes the tilt direction of the electronic pen 500 during the handwriting, the distance between the ultrasonic wave generation unit 510 and the information inputting device 100 is rapidly changed. Accordingly, the position of the electronic pen 500 recognized by the information inputting device 100 is rapidly changed, so that a problem may occur in that inaccurate information inputting may be performed irrespective of the user's intention.

Therefore, in the embodiment of the present invention, this problem is solved by changing the structure of the electronic pen 500 as described below so that the ultrasonic wave signal is emitted toward the touch panel 200.

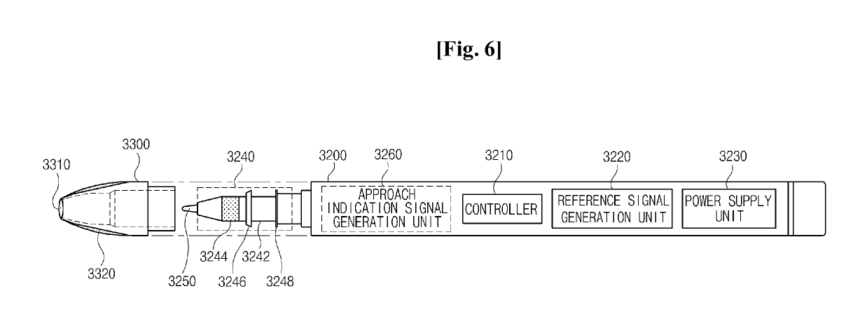

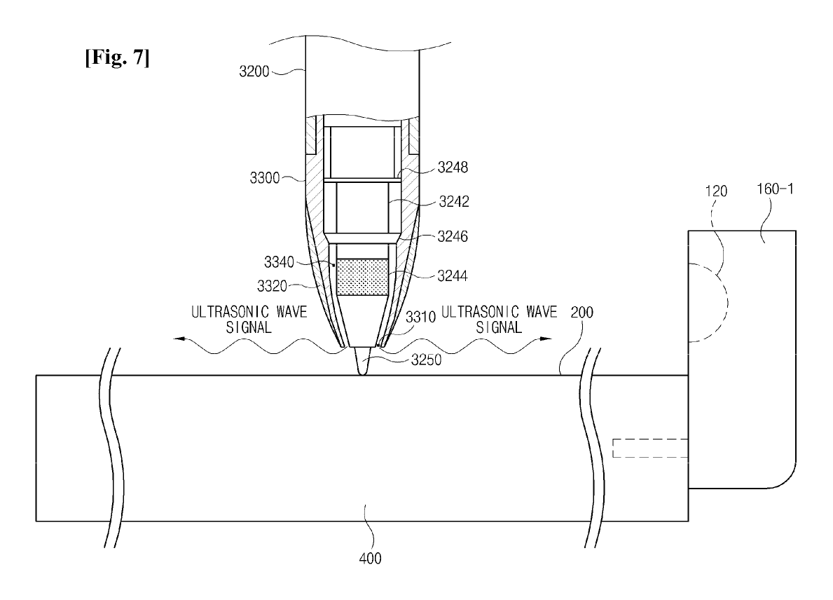

FIG. 6 is a diagram illustrating a structure of the electronic pen 300 according to the embodiment of the present invention. FIG. 7 is a diagram illustrating an example where the electronic pen 300 according to the embodiment of the present invention is used for inputting information.

First, referring to FIG. 6, the electronic pen 300 according to the embodiment of the present invention mainly includes a body portion 3200 and a guide portion 3300 which is engaged with the body portion 3200.

The body portion 3200 basically includes a power supply unit 3230, an ultrasonic wave signal generation unit 3240, a reference signal generation unit 3220, a controller 3210, and a pen core portion 3250. According to some embodiments, the body portion 3200 may further include an approach indication signal generation unit 3260.

The power supply unit 3230 supplies power to the ultrasonic wave signal generation unit 3240, the reference signal generation unit 3220, the approach indication signal generation unit 3260, and the controller 3210. The reference signal generation unit 3220 is supplied with power to generate the reference signal according to the control signal input from the controller 3210. According to the present invention, various signals such as an infrared (IR) signal and a radio frequency (RF) signal may be used as the reference signal.

The controller 3210 outputs a control signal to the ultrasonic wave generation unit and the reference signal generation unit 3220 so that the ultrasonic wave signal generation unit 3240 and the reference signal generation unit 3220 generate an ultrasonic wave signal and a reference signal, respectively, at a predetermined time period. In the case where the approach indication signal generation unit 3260 is installed, the controller 3210 controls the approach indication signal generation unit 3260 to generate an approach indication signal. The generation period of the approach indication signal may be set to be longer than each of the generation periods of the reference signal and the ultrasonic wave signal in order to reduce power consumption.

The pen core portion 3250 may be formed at a distal end of the ultrasonic wave signal generation unit 3240 so as to provide only a feeling of handwriting using a general pen.

On the other hand, the ultrasonic wave signal generation unit 3240 is configured to include a core portion 3242, an ultrasonic wave generation unit 3244, an ultrasonic wave blocking portion 3246, and a supporting portion 3248. The ultrasonic wave signal generation unit 3240 generates an ultrasonic wave signal according to a control signal input from the controller 3210.

The core portion 3242 of the ultrasonic wave signal generation unit 3240 is provided with a cylindrical space at the center thereof so that the pen core portion 3250 can be contained therein. The ultrasonic wave blocking portion 3246 is formed to be protruded up to a certain height from an outer circumferential surface of the core portion 3242, so that the ultrasonic wave blocking portion 3246 is in close contact with an inner surface of the guide portion 3300 described later so as for the ultrasonic wave signal to be emitted in only one direction.

The ultrasonic wave generation unit 3244 is formed so as to surround the outer circumferential surface of the core portion 3242 or formed on a predetermined area of the outer circumferential surface of the core portion 3242. The ultrasonic wave generation unit 3244 generates an ultrasonic wave by converting electric energy applied from the power supply unit 3230 into vibration energy according to a control signal. The ultrasonic wave generation unit 3244 is preferably embodied with a piezo-electric device such as a piezo film. In addition, in order to increase the intensity of the signal, a plurality of the ultrasonic wave generation units can be installed.

The supporting portion 3248 has a function of being in close contact with the inner surface of the guide portion 3300 to fix the position of the ultrasonic wave signal generation unit 3240 in the guide portion 3300.

As illustrated in FIG. 6, when the user performs handwriting by using the electronic pen 300, it is preferable that the ultrasonic wave signal generation unit 3240 be located so as to be close to the surface of the touch panel 200 (for example, located at the “lower end of the electronic pen 300”). The controller 3210, the reference signal generation unit 3220, and the power supply unit 3230 may be disposed at arbitrary positions in the body portion 3200.

On the other hand, the guide portion 3300 is engaged with the body portion 3200 while surrounding the ultrasonic wave signal generation unit 3240 so that the ultrasonic wave signal generated by the ultrasonic wave signal generation unit 3240 is emitted in the direction (hereinafter, referred to as a “direction of the touch panel 200”) where the pen core portion 3250 is abutted on the surface of the touch panel 200.

The guide portion 3300 is provided with a space wherein the ultrasonic wave signal generation unit 3240 is contained therein. The guide portion 3300 is formed to have an overall shape of a cone or a cylinder. In addition, the one end surface of the guide portion 3300 is provided with an insertion portion or a screw thread so as to be engaged with the body portion 3200 through a method of insertion engagement, screw engagement, or adhering engagement with the body portion 3200. The opposite side of the one end surface is provided with an ultrasonic wave emitting portion 3310 so that the ultrasonic wave signal can be emitted.

In addition, a vibration absorbing portion 3320 is disposed in a periphery of the guide portion 3300. In the case of the electronic pen 300 according to the embodiment of the present invention, the ultrasonic wave signal collides with an inner surface of the guide portion 3300 and propagates through an ultrasonic wave guide path 3340 described later toward the touch panel 200. At this time, the intensity of the ultrasonic wave signal is weakened due to the collision with the inner surface of the guide portion 3300.

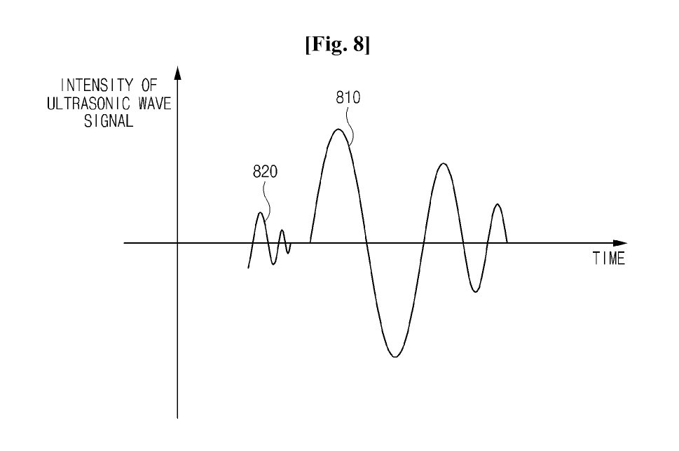

Therefore, in order for the ultrasonic wave reception unit 120 to receive the ultrasonic wave signal of which the intensity is equal to or larger than a predetermined value so that the position can be measured, it is necessary to increase the intensity of the ultrasonic wave signal. However, if the intensity of the ultrasonic wave signal is increased, much more energy is transferred to the inner surface of the guide portion 3300 due to the collision of the ultrasonic wave signal. Therefore, the guide portion 3300 is vibrated, so that a minute ultrasonic wave signal is generated. The ultrasonic wave signal generated is received by the ultrasonic wave reception unit 120, so that the ultrasonic wave signal becomes a noise. FIG. 8 illustrates wave forms of the ultrasonic wave signal 810 emitted by the ultrasonic wave emitting portion 3310 and the ultrasonic wave signal 820 generated due to vibration of the guide portion 3300.

Therefore, in order to more accurately measure the position of the electronic pen 300, it is necessary to prevent the ultrasonic wave signal from being generated due to vibration of the guide portion 3300. In the embodiment of the present invention, a vibration absorbing portion 3320 is disposed in the periphery of the guide portion 3300. The vibration absorbing portion 3320 is allowed to prevent the ultrasonic wave signal from being generated due to vibration of the guide portion 3300. The vibration absorbing portion 3320 may be made of a material capable of absorbing or blocking vibration such as a rubber, a silicon, a high-density synthetic sponge, and a metal. In addition, instead of using the vibration absorbing portion 3320, the guide portion 3300 may be formed to have so thick an outer wall that the guide portion 3300 is not affected by vibration transmitted when the ultrasonic wave signal is generated by the ultrasonic wave generation unit 3244 of the body portion 3200 (in other words, there is no minute ultrasonic wave signal generated due to vibration of the guide portion). Although the thickness of the outer wall of the guide portion depends on the size of the touch panel which is to be used, in the case of the touch panel having 10 inches in the diagonal length, a polycarbonate or transparent ABS guide portion of which the thickness of the outer wall is at least 0.7 mm or less may cause a problem. Therefore, the guide portion needs to be formed to have the thickness of the outer wall which is at least 0.7 mm or more.

FIG. 7 is a diagram illustrating a cross section of the guide portion 3300 in the state where the guide portion 3300 is engaged with the body portion 3200 according to the embodiment of the present invention. Referring to FIG. 7, if the ultrasonic wave signal generation unit 3240 is inserted into the guide portion 3300, the pen core portion 3250 passes through the ultrasonic wave emitting portion 3310 to be protruded outwards, and the ultrasonic wave blocking portion 3246 of the ultrasonic wave signal generation unit 3240 is in close contact with the inner surface of the guide portion 3300 to prevent the ultrasonic wave generated by the ultrasonic wave generation unit 3244 from being emitted toward the opposite side of the handwriting surface.

In addition, in the state where the ultrasonic wave signal generation unit 3240 is inserted into the guide portion 3300, a certain space (hereinafter, referred to as a “guide path 3340”) is formed between the core portion 3242 of the ultrasonic wave signal generation unit 3240 and the inner surface of the guide portion 3300. The ultrasonic wave generated by the ultrasonic wave generation unit 3244 propagates through the guide path 3340 to be emitted through the ultrasonic wave emitting portion 3310.

The information inputting method according to the present invention can also be embodied as computer readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. An information inputting device comprising:
an ultrasonic wave reception unit which receives an ultrasonic wave signal generated by an electronic pen;
a reference signal reception unit which receives a reference signal generated by the electronic pen;
a position measurement unit which measures a position of the electronic pen by using a time difference between a reception time of the reference signal received by the reference signal reception unit and a reception time of the ultrasonic wave signal received by the ultrasonic wave reception unit and inputs second position information indicating the position of the electronic pen; and
an input means selection unit which outputs first position information input from a touch panel, which senses user's contact and outputs the first position information, or the second position information according to user's intention of use.

2. The information inputting device according to claim 1, wherein the input means selection unit determines a user's touched area on the touch panel by using the first position information, outputs the second position information if the touched area exceeds a predetermined first threshold value, and outputs first position information if the touched area does not exceed the first threshold value.

3. The information inputting device according to claim 1, wherein the input means selection unit checks by using the second position information whether or not the electronic pen is located on the touch panel and outputs the second position information in the case where the electronic pen is located on the touch panel.

4. The information inputting device according to claim 3,
wherein the position measurement unit measures a three-dimensional position of the electronic pen and outputs the second position information to the input means selection unit, and
wherein the input means selection unit outputs the second position information in the case where the electronic pen is located on the touch panel and the electronic pen is located within a predetermined height from the touch panel.

5. The information inputting device according to claim 1, further comprising an approach indication signal reception unit which receives an approach indication signal from the electronic pen,
wherein the input means selection unit outputs the second position information in the case where an intensity of a signal received by the approach indication signal reception unit exceeds a predetermined second threshold value.

6. The information inputting device according to claim 1, wherein the electronic pen emits the ultrasonic wave signal toward the touch panel so that the ultrasonic wave signal propagates along a surface of the touch panel.

7. The information inputting device according to claim 6, wherein the electronic pen includes:
a body portion where an ultrasonic wave signal generation unit which generates the ultrasonic wave signal is installed; and
a guide portion which contains the ultrasonic wave signal generation unit therein and is engaged with the body portion so that the ultrasonic wave signal generated by the ultrasonic wave signal generation unit is emitted toward the touch panel.

8. The information inputting device according to claim 7, wherein the guide portion has so thick an outer wall that there is no minute ultrasonic wave signal which is generated due to vibration transmitted when the ultrasonic wave signal is generated in the body portion.

9. The information inputting device according to claim 7, wherein a vibration absorbing portion is disposed in a periphery of the guide portion to prevent an ultrasonic wave signal from being generated due to vibration of the guide portion.

10. The information inputting device according to claim 9, wherein the vibration absorbing portion is made of a material capable of absorbing or blocking vibration.

11. The information inputting device according to claim 10, wherein the vibration absorbing portion is made of any one of a rubber, a silicon, a high-density synthetic sponge, a metal, and a plastic.

12. The information inputting device according to claim 9,
wherein the guide portion includes an ultrasonic wave emitting portion which emits the ultrasonic wave signal in one direction, and
wherein the ultrasonic wave signal generated by the ultrasonic wave signal generation unit propagates through a guide path formed between an inner surface of the guide portion and the ultrasonic wave signal generation unit contained therein to be emitted through the ultrasonic wave emitting portion.

13. The information inputting device according to claim 12, wherein the body portion is provided with an ultrasonic wave blocking portion which is in close contact with an inner surface of the guide portion to block the ultrasonic wave signal so as for the ultrasonic wave signal to propagate in only one direction.

14. A method of inputting information to a portable electronic apparatus in an information inputting device combined with the portable electronic apparatus including a touch panel, comprising steps of:
(a) in the information inputting device, determining which input means between the touch panel and an electronic pen a user is to use to input information;
(b) in the case where it is determined that the user is to input information by using the touch panel, in the information inputting device, outputting first position information indicating a position of the touch panel touched by the user, which is input from the touch panel, to the portable electronic apparatus; and
(c) in the case where it is determined that the user is to input information by using the electronic pen, in the information inputting device, outputting second position information indicating a position of the electronic pen to the portable electronic apparatus.

15. The method according to claim 14, wherein the step (a) includes steps of:
(a1) receiving an area (touched area) of the touch panel touched by the user as an input from the touch panel; and
(a2) determining which input means the user is to use to input information by comparing the touched area with a predetermined first threshold value.

16. The method according to claim 15, wherein the step (a) further includes a step of (a3) in the case where the user is to use the electronic pen to input information, measuring the position of the electronic pen by using a time difference between the ultrasonic wave signal and a reference signal generated by the electronic pen to generate the second position information.

17. The method according to claim 14, wherein the step (a) includes steps of:
(a1) in the information inputting device, measuring the position of the electronic pen by using a time difference between the ultrasonic wave signal and the reference signal generated by the electronic pen to generate the second position information; and
(a2) in the information inputting device, determining an area where the electronic pen is located and determining which input means the user is to use.

18. The method according to claim 17, wherein in the step (a2), in the case where the electronic pen is located above the touch panel, it is determined that the user is to input information by using the electronic pen.

19. The method according to claim 18,
wherein in the step (a1), a three-dimensional position of the electronic pen is measured, and
wherein in the step (a2), in the case where the electronic pen is located above the touch panel and within a predetermined height from the touch panel, it is determined that the user is to input information by using the electronic pen.

20. The method according to claim 14, wherein the step (a) includes steps of:
(a1) receiving an approach indication signal indicating that the electronic pen is operating from the electronic pen; and
(a2) determining which input means the user is to use by comparing the intensity of the approach indication signal with a predetermined threshold value.

21. The method according to claim 20, wherein the step (a) further includes a step of
(a3) in the case where the user is to use the electronic pen to input information, measuring the position of the electronic pen by using a time difference between the ultrasonic wave signal and the reference signal generated by the electronic pen to generate the second position information.

22. A computer-readable recording medium on which a program code is recorded for allowing a computer to execute the method according to claim 14.
